(19) United States
(12) Patent Application Publication
(10) Pub. No.: US 2015/0308731 A1
(43) Pub. Date: Oct. 29, 2015

(54) HEAT EXCHANGER

(71) Applicant: BUNDY REFRIGERATION INTERNATIONAL HOLDING B.V., Amsterdam (NL)

(72) Inventors: Bengt Viklund, Abbekas (SE); Jörg Kirchner, Lipprechterode (DE)

(21) Appl. No.: 14/648,130

(22) PCT Filed: Nov. 27, 2013
(86) PCT No.: PCT/EP2013/074884

§ 371 Date: May 28, 2015

(30) Foreign Application Priority Data
Nov. 30, 2012 (DE) 20 2012 011 541.3
Jul. 9, 2013 (DE) 20 2013 006 214.2

(51) Int. Cl. F25D 21/08; B23P 15/26; F28F 1/00

(52) U.S. Cl. CPC F25D 21/08; F28F 1/00; B23P 15/26

(57) ABSTRACT

A heat exchanger for cooling systems, air conditioning systems, or the like, which is equipped with a de-icing function. For de-icing, the conduits of the heat exchanger are heated and defrosted by an electrical current flow. The drainage of the condensed water is supported by openings in the wings of the wing tubes used.

### 1. TECHNICAL FIELD

The present disclosure relates to a heat exchanger for cooling systems, air conditioning systems or the like, which is equipped with a de-icing function. Furthermore, the heat exchanger may include an insulating sleeve.

### 2. BACKGROUND

In cooling systems of different application, such as in refrigerators from the private sector or the catering industry and in air-conditioning systems, heat exchangers are used to dissipate the heat stored in a cooling liquid or coolant to the environment. Such heat exchangers are made based on different constructions and are known in the art. Other devices with heat exchanger are dehumidifiers for indoor air or air of a room.

Such heat exchangers have a coolant conduit through which the coolant to be cooled flows. Furthermore, such coolant conduits are connected to structures that increase the surface of the coolant conduit for an improved heat exchange with the environment. These structures include, for example fins or lamellae, which are arranged in cascades or like a fan.

During the operation of cooling devices, no matter which type, the heat exchanger reaches a temperature which may be below the dew point of the ambient air. In this case, water condenses from the ambient air to the heat exchanger and is deposited there. If the temperature of the heat exchanger should be below 0° C., the condensed water freezes on the heat exchanger, and an ice or frost formation is formed thereon. This ice or frost formation reduces the heat exchange between the heat exchanger and the ambient air, so that the efficiency of the heat exchanger is reduced.

For this purpose, heating is used in the prior art, which heats, for example, a lamellar or fin structure of the heat exchanger to de-ice or defrost in this way the formed ice or frost layer from the heat exchanger. A known alternative to defrost or de-ice the heat exchanger uses a separate heating loop, which is arranged on the heat exchanger or adjacent to the heat exchanger. This heating loop is arranged separately from the cooling circuit and consists of an electrical heating coil. To defrost the heat exchanger, the heating loop is heated by means of an electric current, so that the heat of the heating loop is radiated towards the heat exchanger.

Such constructions have the disadvantage that a large part of the heat generated is dissipated to the environment. Furthermore, such a defrosting process is tedious, since the heat generated enters the lamellar structure only very slowly.

It is therefore an object of at least some embodiments of a heat exchanger to provide an improved construction for the de-icing of a heat exchanger, a manufacturing method thereof and a suitable de-icing or defrosting method.

### 3. SUMMARY

The above object is and other objects or advantages may be achieved by a heat exchanger according to claim 1, an insulating sleeve according to claim 14, a wing tube according to claim 18, a manufacturing method of a heat exchanger according to claim 22 as well as a de-icing method of a heat exchanger according to claim 26. Advantageous embodiments will become apparent from the description, the drawings and the appending claims.

A heat exchanger for a device, in particular for a cooling device, which has the following features: at least one coolant conduit having a first and a second end, through which a coolant is guidable and which consists of an electrically conductive material, at least one retaining clamp which supports the coolant conduit at least partially, and an electric voltage source, which is connectable to the first and the second end of the coolant conduit or to the ends of at least a section of the coolant conduit so that an electrical heating current flows in the coolant conduit, and/or a second electric voltage source, which is connectable to at least one coil arrangement adjacent to the at least one coolant conduit so that an electrical heating current is inducible in the at least one coolant conduit by a magnetic field of the coil arrangement. Known heat exchangers have at least one coolant conduit that can be provided of electrically conductive material. Already at this coolant conduit, a layer of ice can be formed when the moisture from the ambient air condenses and freezes at the coolant conduit. This is especially the case in cooling devices such as refrigerators and freezers, and hinders the operation of the cooling devices. Since the coolant conduit is the central conduit for heat exchange, initially for dissipation of heat from the cooling liquid or coolant, this coolant conduit is in the same way also suitable for supplying heating power to de-ice or defrost an ice or frost formation. Therefore, by means of at least some embodiments of the present invention, a circuit is formed so that different electrical potentials are connected to the two ends of the coolant conduit or to selected areas/sections of the coolant conduit, so that an electrical current flow through the coolant conduit is generated. This electrical current flow heats the electrically conductive material of the coolant conduit so that a layer of ice located thereon is defrosted directly by heating the coolant conduit.

According to a second alternative, the electrically conductive coolant conduit is heated by an electrical heating current which is induced in it. For this purpose, an electric voltage source supplies a coil arrangement, which is arranged adjacent to the heat exchanger, with electric energy. Due to the electrical supply of the coil arrangement, the coil arrangement generates a magnetic field surrounding at least a coolant conduit of the heat exchanger. According to the known law of induction, a varying magnetic field in an electrical conductor, here the coolant conduit, for example consisting of aluminum or steel, generates an electrical heating current. By means of the strength and change of the magnetic field, the electrical heating current induced in the coolant conduit is selectively adjustable in order to generate a certain heating of the coolant conduit and a defrosting function in the heat exchanger.

Even if the coolant conduit should have additional fins or lamellae and/or other structures which increase the surface of the heat exchanger for an improved heat exchange, these additional structures are connected heat-conductively to the coolant conduit in any case. Therefore, the heat generated by the current flow in the coolant conduit is distributed in these additional structures, for example, fins or wings, so that even there the supplied electrical heat results in a defrosting of an existing ice layer. It is also preferable to apply the above-described heating function on coolant conduits having no surface-enlarging structures, such as wings or fins. Such coolant conduits are preferably used in tube evaporators or similar constructions in which the heat exchanger consists of a curved conduit, preferably a spiral or helical conduit.

Depending on the strength of the electrical current through the coolant conduit also the heat output of the coolant conduit can be varied. It follows that the intensity of heating and the length of time for the heating is selectively adjustable to the existing ice layer to be de-iced. This enables an energy-efficient handling with the de-icing function of the heat exchanger.

According to at least some implementations of a heat exchanger, the coolant conduit of the heat exchanger is preferably made of metal. The at least one retaining clamp is made of an electrically non-conductive material. In addition, preferably, the electrical voltage source is a low-voltage source with direct or alternating voltage.

According to a preferred embodiment of the inventive heat exchanger, the coolant conduit is a wing tube consisting of a tube and a plurality of wings extending radially therefrom, preferably two wings which are arranged oppositely to each other. The wings of the wing tube are formed flat and have a plurality of openings in the longitudinal direction of the wing tube, which are arranged spaced from each other.

By means of the known wing tubes, the surface of the coolant conduit is increased to dissipate heat to the environment. Once water or ice concentrates on the wing tube of the heat exchanger, the efficiency of the heat exchanger decreases. For it is not the entire face area of the wing tube and thus of the heat exchanger which is available for a heat exchange with the environment. Therefore, it is preferred according to at least some embodiments of the heat exchanger to provide the wings of the wing tube with a plurality of openings through which the water can drain that would otherwise accumulate or concentrate on the wing tube. Even if ice should accumulate on the wings, the water resulting after the start of a defrosting procedure of this ice could run off and/or drain through these openings.

In order to ensure optimum water drainage, the openings preferably have a cross-sectional area A_{D} in the range of 2 mm²≦A_{D}≦50 mm², more preferably of 8 mm²≦A_{D}≦32 mm² and even more preferably of 10 mm²≦A_{D}≦15 mm² In addition, it is preferable to construct the openings approximately in a rectangular, elliptical, or round shape. The openings may have the form of an oblong hole, the shorter sides of which are rounded or straight. Preferably, the openings and the wings are stamped.

To protect the device connected to the heat exchanger, preferably a refrigerator for home and gastronomic use or retail, an air conditioning system, a dehumidifier for indoor air, with respect to the electrical voltage of the heating function of the heat exchanger, the coolant circuit of the device is electrically insulated from the coolant conduit, preferably the first and the second end of the coolant conduit is connected, respectively, by means of an insulating sleeve to the coolant circuit of the device. In this way, it is ensured that the electrical circuits of the device connected to the heat exchanger will not be affected by the electrical heating current for de-icing or heating the heat exchanger. Since the coolant flowing through the coolant conduit is not electrically conductive, it is only necessary to electrically insulate the coolant conduit with respect to the connected device. It is not necessary to electrically insulate the coolant itself from the coolant conduit.

According to at least some embodiments, the insulating sleeve of the heat exchanger comprises a hollow cylindrical body with two opposite ends, each comprising an annular gap for connecting conduits. In at least some embodiments, this annular gap is formed by a radial inner wall and a radial outer wall of the insulating sleeve. In order to ensure the function of the insulating sleeve, the hollow cylindrical body of the insulating sleeve is made of an electrically non-conductive material. As the insulating sleeve is preferably usable also for the connection of any conduit ends, also electrically conductive material is usable for the hollow cylindrical body. As one can specifically choose the material for the body of the insulating sleeve, in this manner conduits made of different materials and having different thermal and/or chemical loads can be connected. On the one hand, the loads of the conduits do not negatively affect the established connection due to this construction of the insulating sleeve. On the other hand, electrochemical corrosion is preferably reduced or eliminated by the materials of the connected conduits. The same applies to the choice of the material of the annular inserts (see below).

The respective annular gap at the first and the second end of the insulating sleeve is preferably arranged concentrically with respect to the central axis of the insulating sleeve. This annular gap has such a width in the radial direction that a conduit end of the coolant conduit can be inserted and fastened therein. In order to produce an optimal connection between the insulating sleeve and the conduit ends, the annular gap is adaptable in its axial depth relative to the central axis of the insulating sleeve for being able to accommodate a sufficiently long portion of the conduit end of the coolant conduit.

According to another preferred embodiment, the insulating sleeve comprises at least one annular insert, which is insertable into the annular gap to hold the conduit end of the annular gap. This annular insert is preferably conical and/or stepped in the axial direction. If the annular insert and the conduit end is inserted into the annular gaps of the insulating sleeve, this creates an interference fit of the annular insert and the conduit end in the annular gap of the insulating sleeve. In this manner, the conduit end is fixed reliably in the heat exchanger, wherein preferably at the same time a liquid-tight connection between the heat exchanger and the device is created by the interference fit. It is also preferred to wet the annular gap with an adhesive for improving the connection between the insulating sleeve and the conduit end in this manner.

According to a further preferred embodiment of the heat exchanger, at least two sections of the coolant conduit are electrically connected to each other so that the electrical heating current can spread accordingly. Even if it has proved advantageous to provide the coolant conduit having a surface area as large as possible, a defrosting or heating of the coolant conduit is also supported by an electrically conductive contact between the coolant conduits or sections of the coolant conduits. This is because such an electrical connection transmits an applied or induced electrical heating current from a section of the coolant conduit to, for example, a neighboring section of the coolant conduit. In this way it is ensured that the electrical heating current flows through areas of the heat exchanger which are as large as possible, whereby the effectiveness of the here realized defrosting function is increased.

With respect to the inventive alternative with the usage of a coil arrangement for generating an electrical heating current, it is also preferred that the at least one coil arrangement has an annular structure, which surrounds at least one coolant conduit. The inventively preferred annular coil arrangement has the result that the coolant conduit passing through the annular structure is exposed to a strong magnetic field in the inside of the annular structure. Using a properly adjusted electrical alternating voltage or a circuitry-wise differently realized variation of the strength of the magnetic field of the annular coil arrangement, high or effective electrical heating currents can be induced just inside the annular coil arrangement. Alternatively, it is of course also preferable to use at least one coil arrangement with a flat, curved or a design as required by the shape of the heat exchanger so that the at least one coil arrangement can be arranged adjacent to the heat exchanger, preferably adjacent to the at least one coolant conduit. The shape of the coil arrangement is chosen such that the coil arrangement is positionable at the at least one coolant conduit as closely as possible and on the other hand does not impede the flow of air through the heat exchanger. Therefore, it is preferable to dispose, for example, one or a plurality of planar or flat coil arrangements in the outer circumferential portion of the heat exchanger. A further alternative embodiment is to surround several portions of the coolant conduit of the heat exchanger by a respective annular coil arrangement so that the respective annular coil arrangement induces an individual electrical heating current in each corresponding section of the coolant conduit.

According to another preferred embodiment, the already above discussed at least one coil arrangement is connected to an electrical controller by means of which a frequency of an electrical supply voltage of the at least one coil arrangement is adjustable. The technical background of this preferred embodiment is that it has been shown in experiments that with increasing frequency of the electrical alternating voltage supplying the at least one coil arrangement, the electrical heating current induced in the at least one coolant conduit increases, and thus the induced electric heating power. In order to use this effect advantageously, it is therefore preferred to adjust the frequency of the electrical supply voltage of the at least one coil arrangement according to the present construction of the heat exchanger and/or the material of the coolant conduit in such a way that an optimum heating or warming function of the heat exchanger can be realized. In this context, and with respect to a plurality of coil arrangements used in the heat exchanger, it is also preferred to provide these with the same or with individual alternating voltages.

According to another preferred embodiment, the at least one coil arrangement is connected to a controller, which includes a timer for time-dependent activation and deactivation of the magnetic field of the coil arrangement. By means of the timer it is ensured that the defrost or heating function of the heat exchanger by means of the induced electrical heating current is performed at specific periods of operation or operating conditions of the heat exchanger. Furthermore, the timer ensures how long the defrost function unfolds its effect. Regardless of the timer, it is also preferable to activate the defrost function by means of a sensor that detects the icing-up condition of the heat exchanger. Accordingly, the defrost function can be switched off again when such a defrost sensor could detect a sufficient de-icing of the heat exchanger.

In addition, at least certain implementations may include a device with heat exchanger according to one of the above-described embodiments. The device is preferably a cooling device, an air conditioning system or a drying device.

Further, a manufacturing method of a heat exchanger with heating, may comprise the steps of: providing a coolant conduit having a first and a second end and consisting of an electrically conductive material, arranging the coolant conduit in at least one retaining clamp and providing an electrical connection to the first and second end of the coolant conduit to which a switchable voltage source can be connected so that an electrical current flows through the coolant conduit, and/or providing at least one coil arrangement adjacent to at least one coolant conduit which is connected to a second switchable electrical voltage source. The constructive characteristics of the components of the heat exchanger with heating and/or coil arrangement which are used in the manufacturing method are described in detail above.

According to a preferred embodiment of the manufacturing method, a connecting of the coolant conduit with a coolant circuit of a device takes place by means of an insulating sleeve so that the device is electrically insulated from the coolant conduit. It is further preferred to arrange a plurality of coil arrangements in the heat exchanger. A de-icing method of a heat exchanger of a device having a coolant conduit of electrically conductive material is also disclosed, wherein the de-icing method comprises the steps of: applying a first electrical voltage to a first and a second end of the coolant conduit which is electrically insulated with respect to the device so that an electrical current flows through the coolant conduit and heats the coolant conduit, and disconnecting the first electrical voltage after a period of time so that the coolant conduit is no longer heated, and/or applying a second electrical voltage to at least one coil arrangement adjacent to the at least one coolant conduit so that a magnetic field of the at least one coil arrangement induces an electrical heating current in the at least one coolant conduit, and disconnecting the second electrical voltage after a period of time so that the coolant conduit is no longer heated.

Based on the above described construction, different electrical potentials can be applied to the two ends of the coolant conduit or to the ends of selected sections of the coolant conduit such that an electrical current flows through the coolant conduit. These different electrical potentials can be a direct as well as an alternating voltage. Since the coolant conduit is preferably made of metal, the current flow through the coolant conduit leads to a heating of the coolant conduit. Alternatively, or in addition to the de-icing method just described, the electrical heating current in the coolant conduit is also inducible through the at least one coil arrangement adjacent to the heat exchanger. It is preferred to vary the strength of the electrical heating current depending on the degree of icing-up of the heat exchanger, for example by varying the frequency of an alternating voltage supplying the coil arrangement. With increasing frequency of this second alternating voltage, the current strength of the electrical heating current induced in the coolant conduit increases. Furthermore, it is preferred to supply different coil arrangements in the heat exchanger with different electrical alternating voltages to adjust the defrosting function to the local conditions in the heat exchanger, depending on the location of the coil arrangement in the heat exchanger. It is also preferred to optimally adapt the defrosting function by means of the use of different coil constructions. According to a further preferred embodiment of the present de-icing method, the strength of the induced electrical heating current can be adjusted by means of the amount of the electrical alternating voltage supplying the respective coil arrangement. Because the induced heating current increases with increasing amount of the supplying alternating voltage for the coil arrangement and therefore with increasing strength of the magnetic field generated.

The heat generated by means of the electrical heating current defrosts or de-ices a frost or ice layer present on the coolant conduit so that due to this de-icing function the heat exchanger returns to its original efficiency. The electrical current flow through the coolant conduit is preferably started in response to a formed frost or ice layer on the heat exchanger. This frost formation can be detected by means of a sensor, for example an optical sensor. A control unit then starts in response to a signal from the sensor the current flow through the coolant conduit which results in the defrosting of the ice layer. In the same way, it is possible to monitor the result of the defrosting process with this or a further sensor. If the sensor has detected a sufficient defrosting, the electrical voltage or the current flow in the coolant conduit can be switched off in response to a corresponding signal.

Therefore, the de-icing method may comprise the steps of: detecting an icing-up on the heat exchanger by means of a sensor, applying the electrical voltage to a coolant conduit of the heat exchanger and/or generating a changing or varying magnetic field in at least one coil arrangement of the heat exchanger after a certain degree of icing-up has been reached so that an electrical heating current flows in the coolant conduit, and switching off the electrical voltage and/or the magnetic field after falling below a certain degree of icing-up.

According to a further preferred embodiment, the temperature of the coolant in the coolant conduit during the de-icing of the heat exchanger is monitored. Thereby, it is preferably excluded that the cooling liquid is overheated during the defrosting of the heat exchanger, i.e. during the heating electrical heating current flows through the coolant conduit.

### 4. BRIEF DESCRIPTION OF THE ACCOMPANYING DRAWINGS

Some presently preferred embodiments of a heat exchanger and related components, methods and the like will be explained in more detail with reference to the accompanying drawings. It shows:

FIG. 1 a schematic perspective view of a preferred embodiment of the heat exchanger,

FIG. 2 a perspective view of a preferred embodiment of a coolant conduit of the heat exchanger of FIG. 1,

FIG. 3 preferred embodiment of a tube evaporator,

FIG. 4 a preferred embodiment of a conduit connection with insulating sleeve,

FIG. 5 a side sectional view of the conduit connection according to FIG. 3,

FIG. 6 an enlarged view of the encircled area of FIG. 4,

FIG. 7 an exploded perspective view of the preferred insulating sleeve,

FIG. 8 a side view of a preferred embodiment of the insulating sleeve,

FIG. 9 a side sectional view of the insulating sleeve of FIG. 7, and

FIG. 10 a simplified schematic diagram of the preferred heat exchanger having a coil arrangement for the induction of an electrical heating current in the coolant conduit,

FIG. 11 a preferred embodiment of a wing tube with openings in the wings, and

FIG. 12 an enlarged view of a preferred embodiment of an opening.

### 5. DETAILED DESCRIPTION OF THE PREFERRED EMBODIMENTS

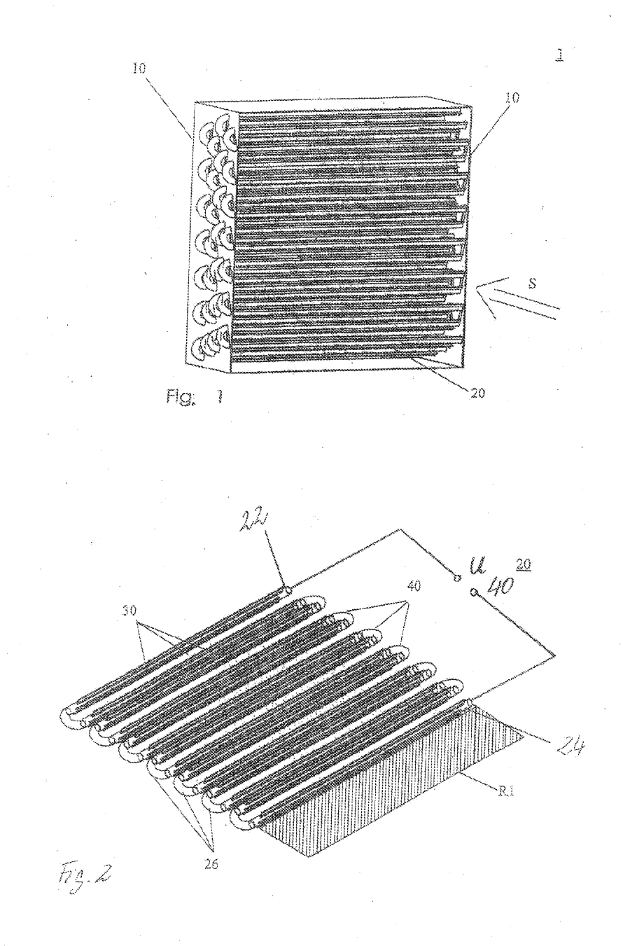

In the prior art, heat exchangers of different construction are known. A known heat exchanger 1 is shown in FIG. 1 schematically. This heat exchanger 1 comprises at least one cooling conduit 20, which is preferably bent in a serpentine shape (see FIG. 2). Such a heat exchanger 1, its coolant conduit 20 and its specific constructive features are described in detail in DE 10 2012 005 513.

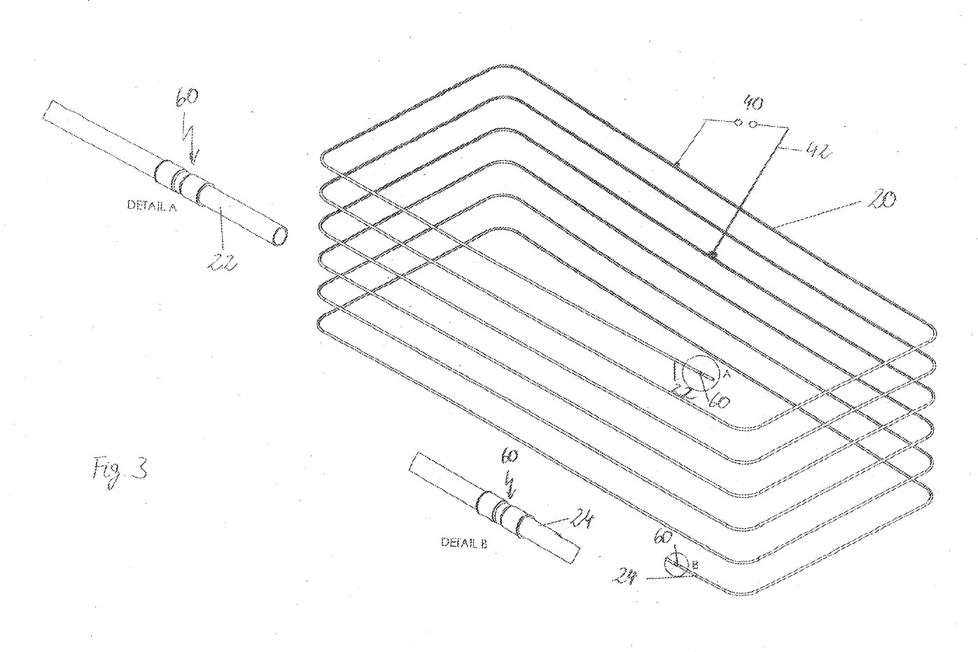

Preferably, there are also other heat exchangers 1 combinable with at least certain aspects or embodiments of the present invention. These heat exchangers have, for example, a coolant conduit 20 with flat-like fins or lamellae (not shown), a coolant conducting tube without increased surface area, such as in a tube evaporator according to FIG. 3, or other constructions increasing the heat exchange surface of the coolant conduit 20. In the following, at least certain aspects or embodiments will be explained based on the example of the heat exchanger according to FIGS. 1 and 2. The described properties apply equally to other heat exchangers, such as the tube evaporators of FIG. 3.

Air flow streams against the at least one coolant conduit 20 in a flow direction S (see FIG. 1) in order to realize a heat exchange between coolant conduit and environment.

The coolant conduit 20 preferably includes a coolant inlet 22 and a coolant outlet 24, so that a cooling fluid of a cooling circuit of a device can flow through the coolant conduit 20. Such devices with cooling circuit (not shown) include refrigerators or walk-in refrigerators in personal and industrial sectors, air conditioning systems, refrigerators for vehicles and dehumidifiers, to name just a few examples.

The coolant conduit 20 is preferably formed as wing tube in certain sections. Such wing tubes consist of a tube or conduit and at least two wings extending radially therefrom. It is also preferred that more than two wings are arranged circumferentially distributed on the tube.

According to various preferred embodiments, the wings of the wing tube are formed planar or flat or they are curved arc-shaped, as described in DE 10 2012 005 513 and PCT/EP2013/051422. For explaining the design and function of wing tubes, it is clearly referred to the disclosure of said applications.

As has been explained above already, a layer of ice may be formed on the coolant conduit 20 during operation of heat exchangers 1. To remove the layer of ice, the heat exchanger 1 has a heating function. By means of the heating function, the ice layer is converted into water. The heating function is realized by an electrical current flow directly in the coolant conduit 20 so that the coolant conduit 20 is heated and thereby defrosted or de-iced. For this purpose, the coolant conduit 20 is made of an electrically conductive material, such as steel, aluminum or other suitable metals or metal alloys.

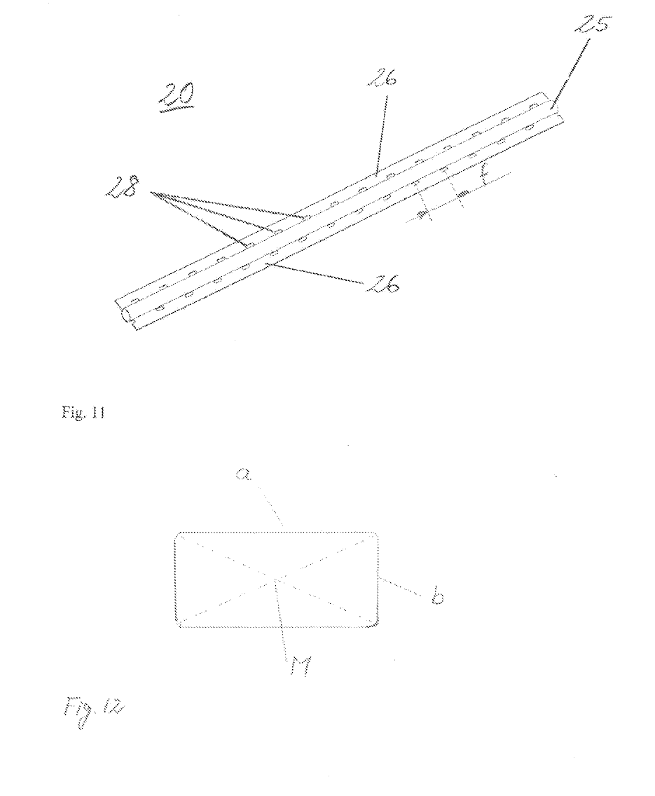

It has been found that the melted water often adheres or stops on the wings or at the transition between wing and tube. The same is true for condensate, which is deposited on the wing tube. This water hinders the heat exchange between the heat exchanger and the environment. In order to remove the water from the wing tubes 20, a plurality of openings 28 is provided on a wing 26, a selection of the wings 26 or on all wings 26 of the wing tube 20. According to a preferred embodiment, the openings 28 are arranged adjacently to the tube 25, as can be seen in FIG. 11. It is also preferred to arrange the openings 28 centrally in a radial direction of the wing 26.

The shape of the openings 28 is preferably similar to a rectangular or elongated hole, elliptical, oval, round, triangular or quadrangular. If the opening 28 has the form of an elongated hole, the cut sides are straight or curvilinear. In addition, the longitudinal axis of the elongated hole extends parallel to the longitudinal axis of the wing tube. Furthermore, other forms are also conceivable, as long as they ensure the removal of water or liquid from the wing tube 20.

Preferably, the openings 28 have a sufficiently large cross-sectional area so that the surface tension of the water or a liquid to be removed does not prevent or impede a draining through the openings 28. The openings therefore have a preferred cross-sectional area A_{D} in the range of 2 mm²≦A_{D}≦50 mm², more preferably of 8 mm²≦A_{D}≦32 mm² and even more preferably of 10 mm²≦A_{D}≦15 mm² Furthermore, the openings 28 have a longitudinal side a, preferably parallel to the longitudinal axis of the wing tube, in the range of 2 mm≦a≦10 mm, more preferably of 4 mm≦a≦8 mm, and even more preferably of a=6 mm. The longitudinal sides a are preferably spaced apart from each other for the distance b, wherein 1 mm≦b≦5 mm, more preferably 2 mm≦b≦4 mm, and even more preferably 2.4 mm≦b≦2.5 mm. It is further preferred to arrange the openings 28 at a predetermined distance f from each other. This distance f is measured between the centers of adjacent openings 28. The distance f is preferably in the range of 5 mm≦f≦40 mm, more preferably of 10 mm≦f≦30 mm, even more preferred in the range of 15 mm≦f≦25 mm and according to at least some implementations the distance f is f=20 mm.

The first end 22 and the second end 24 of the coolant conduit 20, forming the coolant inlet 22 and the coolant outlet 24, are connected to an electrical voltage source 40. It is also preferred according to at least some implementations to heat at least a section of the coolant conduit 20. For this purpose, the ends of at least a section of the coolant conduit 20 are connected to the electrical voltage source (see FIG. 3). Such a connection is preferably realizable by clamping, gluing, soldering or welding of the connecting wires 42 to the voltage source 40 to the coolant conduit 20. The electrical voltage source 40 is a direct or alternating voltage source. According to a preferred embodiment, a low voltage source in the voltage range of 4 V to 20 V, preferably of 6 V to 12 V, more preferably of 6 V is used. Since the heat exchanger 1 is connected to a device (not shown) which also contains electrical circuits, especially an electrical low voltage of the heat exchanger 1 can be insulated simply from the remaining device.

It is also preferred to connect the electrical voltage source 40 remote from the first 22 and second end 24 of the coolant conduit 20 to the coolant conduit 20.

Since the coolant conduit 20 is preferably disposed in a housing of the heat exchanger 1, as shown in FIG. 2, it is fastened laterally in at least one retaining clamp 10. The retaining clamp 10 has openings, for example elongated or oblong holes, in which the bent portions of the coolant conduit 20 are held. In order to avoid an electrical short circuit between adjacent portions of the coolant conduit 20, the at least one retaining clamp 10 is made of an electrically non-conductive and temperature-resistant material, preferably plastic. In this way it is ensured that the electrical heating current of the voltage source 40 flows through the complete coolant conduit 20 or the at least one section of the coolant conduit and thereby heats and defrosts it.

After the coolant conduit 20 has been arranged in the at least one retaining clamp 10, the voltage source 40 is electrically connected to the coolant inlet 22 and the coolant outlet 24 or to the ends of the at least one selected section of the coolant conduit 20. Once an electrical potential difference between the coolant inlet 22 and the coolant outlet 24 or the two ends is applied, an electrical current flows through the coolant conduit 20, which heats it and defrosts the ice.

To this end, the voltage source 40 can be selectively switched on and off, which is preferably controlled by a control unit (not shown). It is further preferred that the power supply of the voltage source 40 is variable, as the heat generated in the coolant conduit 20 is adjustable by means of the strength of the current flowing in the coolant conduit 20.

The switching on and off of the voltage source 40 is preferably realized with the support of a sensor (not shown). This sensor, preferably an optical sensor or a temperature sensor detects the ice or frost formation on the coolant conduit 20. If an adjustable threshold value of the ice formation is exceeded, the voltage source 40 is switched on so that an ice defrosting heating current flows through the coolant conduit 20.

If the sensor detects that the ice has been thawed sufficiently after a certain period or an adjustable period of time has elapsed without sensor detection, the voltage source 40 is switched off again. This switching off process is therefore preferably performed based on the signal of the sensor or in a time-controlled manner after a certain period of time has elapsed. In cooling devices, such as freezers or refrigerators, it is preferred to start the heating function depending on the number of opening operations of the cooled space.

This is preferably the case at tube evaporators according to FIG. 3, which are used in refrigerators. By directly heating the coolant conduit 20 of the evaporator tube or of selected sections of the coolant conduit 20, a quick defrosting of the evaporator tube can be realized. At the same time, separate heating coils or time-consuming defrosting phases of such refrigerators can be avoided.

It is also preferred to monitor the coolant temperature during the defrosting operation by means of heating current. This precludes that the heating current overheats the coolant. Preferably, a temperature sensor (not shown) is arranged in the coolant flow therefor.

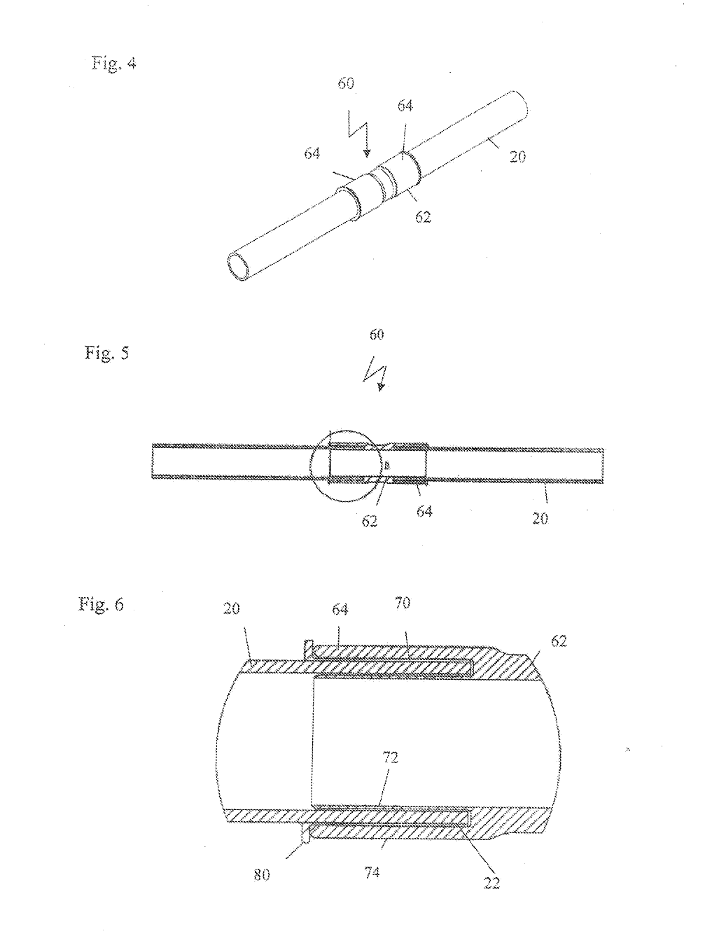

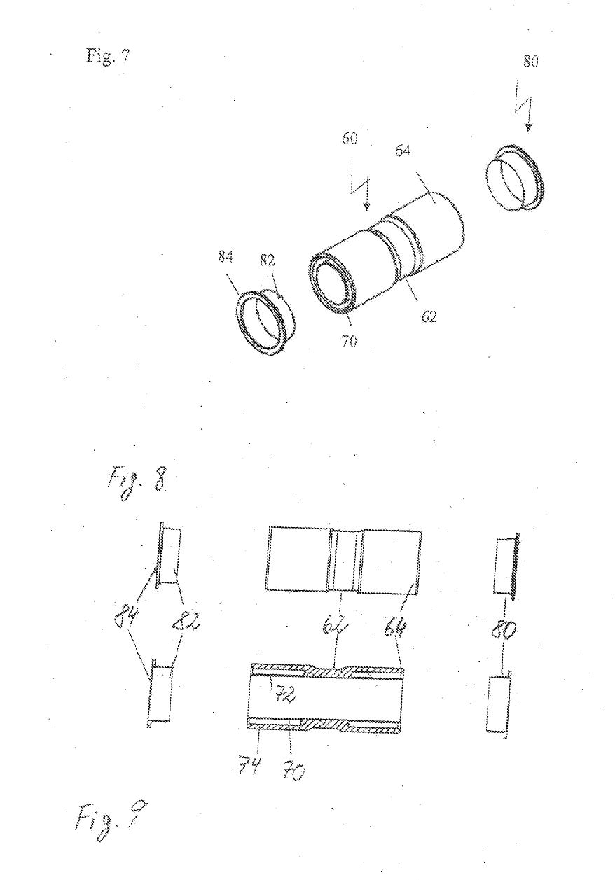

According to another preferred embodiment, the coolant conduit 20 with heating function is electrically insulated with respect to the coolant circuit of a device (not shown) connected to the heat exchanger 1. For this purpose, at least one end 22; 24 of the coolant conduit 20, preferably both ends 22, 24 are connected to the coolant circuit of the device by means of an insulating sleeve 60 (see FIG. 4-9).

The insulating sleeve 60 is made of an electrically non-conductive and temperature-resistant material, preferably plastic, so that the current flowing in the coolant conduit 20 does not reach the coolant circuit of the device. A preferred embodiment of the insulating sleeve 60 is illustrated in FIGS. 3-8.

The insulating sleeve 60 comprises a hollow cylindrical body 62 with two opposing connection ends 64. In the axial direction of the insulating sleeve 60 an annular gap 70 extends to the connection ends 64 each within the hollow cylindrical wall of the body 62. The annular gap 70 is delimited by a radially inner wall 72 and a radially outer wall 74 of the body 62. Moreover, this annular gap 70 is adapted in its gap width to a wall thickness of a conduit to be received, preferably a connection end of the coolant conduit 20, so that the connection end 22; 24 is receivable in the annular gap 70.

Preferably, the connection end 22; 24 is mounted in the annular gap 70 by an interference fit and/or adhesive bonding. Furthermore, preferably the fastening or the retaining of the connection end 22; 24 is supported by an annular insert 80. Before inserting the connection end 22; 24 in the annular gap 70, the annular insert 80 is pushed on the connection end 22; 24. After the connection end 22; 24 has been inserted into the annular gap 70, the annular insert 80 is also pressed into the annular gap 70. Due to its form, the annular insert 80 amplifies the interference fit of the connection end 22; 24 in the annular gap 70. Preferably, an adhesive being present in the gap 70 is compressed, divided and/or superfluous adhesive is pressed out by the annular insert 80.

The annular insert 80 is composed of a tubular section 82 and a circumferential collar 84, which preferably extends perpendicular to the longitudinal axis of the annular insert 80. The circumferential collar 84 is supported when installed on the body 62 of the insulating sleeve 60 so that the annular insert 80 cannot be completely pushed into the annular gap 70.

Preferably, the annular section 82 tapers at its radial outer side conically or stepwise in the direction of its end facing away from the collar 84. Thereby, the tubular portion 82 receives a wedge-like shape, which anchors the annular insert 80 together with the connection end 22; 24 in the annular gap 70 firmly.

The annular insert 80 is made of the same or a similar material as the body 62 of the insulating sleeve 60. It is also preferred to prepare the body 62 of the insulating sleeve 60 of a translucent plastic so that for example a light activatable adhesive for bonding a connection end 22; 24 can be used in the annular gap 70. According to another preferred embodiment, an adhesive is used which is cured by means of heat.

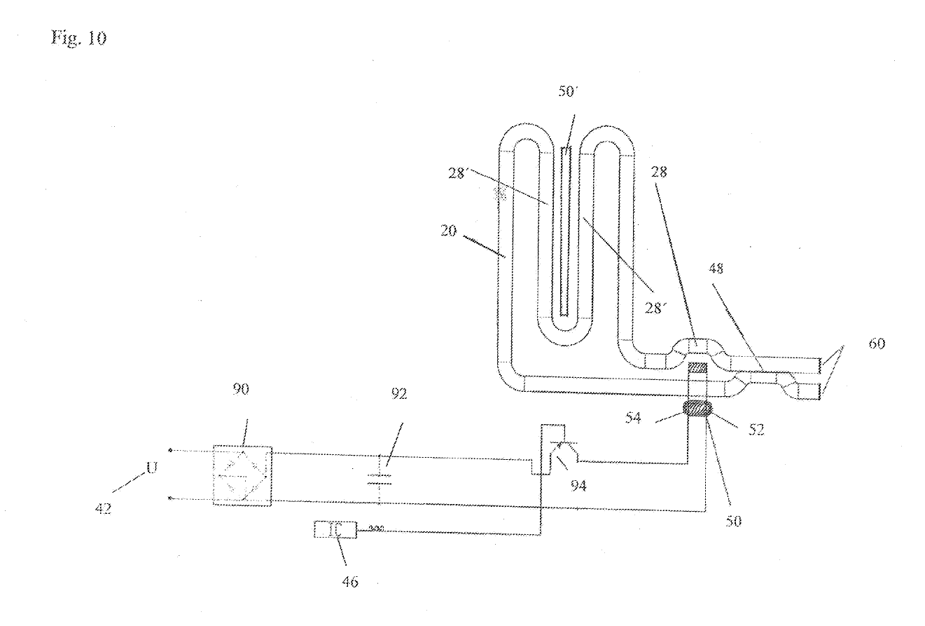

FIG. 10 shows a schematic representation of another preferred embodiment of the heat exchanger. The heat exchanger has the same or a selection of the structural features as they have already been described above in the discussion of the heat exchanger of FIGS. 1-9. In contrast to the above-described heat exchanger, the heat exchanger of FIG. 10 includes a warming-up or a defrosting device, which is based on the principle of electromagnetic induction. By means of electromagnetic induction, the heating of electrically conductive materials can be carried out. For this purpose, a changing or varying magnetic field is generated by means of an electrical alternating voltage and a corresponding electrical alternating current by means of an induction coil. The workpiece to be heated and made from an electrically conductive material is positioned in the changing magnetic field. Since this magnetic field of the coil overcomes the air gap to the adjacently arranged workpiece, the varying magnetic field can couple into the electrically conductive workpiece. For this reason, an electrical voltage is induced by the magnetic field in the workpiece, which causes an electrical current flow, in particular an eddy current, in the range of the applied magnetic field.

The defrosting or de-icing device based on the principle of electromagnetic induction is preferably used alone or in combination in the heat exchanger with the warming-up or defrosting device already described above.

The defrosting device includes a voltage source 42 which is electrically connected to a coil arrangement 50. An arbitrarily shaped structure having a plurality of wire windings 54 is understood under a coil arrangement 50 which generates the above-mentioned magnetic field. As soon as an electric voltage U is applied to the wire winding 54, a magnetic field is built up around the coil arrangement 50 (not shown). The coil arrangement 50 preferably has an annular structure, inside which an iron core 52 is arranged to amplify the magnetic field. According to another preferred embodiment, the annular coil arrangement 50 surrounds the coolant conduit 20.

For being able to arrange the coil arrangement 50 adjacent to or in the vicinity of the coolant conduit 20, it is formed flat or curved or adapted in its shape to the heat exchanger.

The coil arrangement 50, preferably a plurality of coil arrangements 50 arranged distributed in the heat exchangers, is powered by the voltage source 42 with the electric voltage U. The voltage source 42 provides an alternating voltage U, which is supplied directly to the coil arrangement 50. According to another embodiment, the alternating voltage U is rectified through a rectifier 90 and subsequently modified by means of an electric control 46 for an optimal operation of the coil arrangement 50. To this end, the controller 46 preferably includes a frequency generator in order to be able to adjust the frequency of the voltage U arbitrarily. The frequency generator generates frequencies of the alternating electric voltage U in the range of 50 Hz to 10 MHz, preferably of 50 Hz to 100 kHz. For switching the currents flowing through the coil arrangement 50, preferably a circuit breaker, for example a transistor, is used.

As soon as an alternating voltage U is applied to the at least one coil arrangement 50 by the voltage source 42 and the controller 46, the alternating voltage U generates a magnetic field constantly changing according to the frequency of the alternating voltage U. The magnetic field surrounds the coil arrangement 50 and the adjacent thereto arranged section 28 of the coolant conduit 20. Since the coolant conduit 20 is composed of electrically conductive material, such as aluminum or steel, the changing magnetic field induces an electrical heating current in the section 28 of the coolant conduit 20. This electrical heating current is also referred to as an eddy current. The electrical heating current flows through the coolant conduit 20 and heats in this manner the coolant conduit 20, as has been described above.

In order to distribute the magnetically induced electric heating in the coolant conduit 20 better and therefore to exploit it better, preferably at least one electrically connecting portion 48 is provided. The portion 48 provides an electrical connection between adjacent sections of the coolant conduit 20, whereby the induced electrical heating current or at least a heat generated in this portion of the coolant conduit may flow to regions of the coolant conduit 20 adjacent to the coil arrangement 50.

For making the magnetic field of the coil arrangement 50 to act on large portions of the coolant conduit 20, preferably flat coil arrangements 50 are used. The changing magnetic field of the coil arrangement 50 preferably covers elongated portions 28′ of the coolant conduit 20 so that electrical heating currents are induced there. In this context, all arbitrary forms of coil arrangements 50 are preferred which allow an effective induction of the electrical heating current in large regions of the coolant conduit 20 and/or in several juxtaposed coolant conduits 20.

With the below equation (1), preferably a power attainable by the electrically induced heating current is approximately determinable. In this case, K_{ind} is a factor to describe the efficiency of the inductive power transmission and depends on the shape of the coil arrangement 50. The equation (2) preferably represents a dependency of the penetration depth δ of the electrical heating current in the coolant conduit 20 from the material properties of the material of the coolant conduit 20 and the frequency f of the alternating current and the alternating voltage U in the coil arrangement 50. Among the mentioned material properties, the relative permeability μᵣ and the specific resistance ρ have to be numbered.

$$\begin{matrix}{P}_{ind} = {K}_{ind} \cdot {i}^{2} \cdot \sqrt{{μ}_{r} \cdot {μ}_{0} \cdot ρ \cdot f} & ( 1 ) \\ δ = 503 \cdot \sqrt{\frac{ρ}{{μ}_{r} \cdot f}} & ( 2 )\end{matrix}$$

On the basis of studies it has been shown that with increasing frequency the changing electrical voltage U supplying the coil arrangement 50, the electromagnetic power input in the coolant conduit 20 increases. As an example, the following table shows achievable electromagnetic power values for a coolant conduit 20 made of aluminum and steel. The results shown in the table highlight that advantageously a high-frequency alternating voltage should be used to power the coil arrangement 50. Such a high-frequency alternating voltage U can be achieved by the frequency generator already mentioned above as part of the controller 46.

| | | | relative | Specific | | |
|---|---|---|---|---|---|---|
| | | | perme- | electrical | | Power |
| | K_{ind} | Current | ability | resistance | Frequency | P_{ind} |
| Alternative | [1] | i [A] | μᵣ [1] | [mm²/m] | f [Hz] | [W] |
| Al 50 Hz | 1 | 5 | 1 | 0.0265 | 50 | 0.032 |
| Al 1 kHz | 1 | 5 | 1 | 0.0265 | 1000 | 0.144 |
| Al 100 kHz | 1 | 5 | 1 | 0.0265 | 100000 | 1.443 |
| St 50 Hz | 1 | 5 | 1000 | 0.1 | 50 | 1.982 |
| St 1 kHz | 1 | 5 | 1000 | 0.1 | 1000 | 8.862 |
| St 100 kHz | 1 | 5 | 1000 | 0.1 | 100000 | 88.623 |

In the above table, the first column describes the material of the coolant conduit and the electrical frequency of the used alternating voltage. The abbreviation AI emphasizes that the coolant conduit 20 is made of aluminum. The abbreviation St indicates that the coolant conduit is made of steel. The indication 50 Hz, 1 kHz, etc. indicate that an alternating electric voltage U has been used at a frequency of 50 Hz or 1 kHz. The frequencies are again mentioned in the column called “frequency f”. Furthermore, the table lists the preferably used currents and different material properties. In the right column of the table then the electromagnetic power that could be preferably induced by means of the coil arrangement 50 in the coolant conduit 20 is found.

It is also preferable that the controller 46 includes a timer switch or timer with which the magnetic field of the coil arrangement 50 can be selectively switched on and off.

1. Heat exchanger for a device, comprising the following features:
at least one coolant conduit having a first and a second end through which a coolant can be guided and which consists of electrically conductive material,
at least one retaining clamp, which at least partially supports the coolant conduit, and at least one of a first electric voltage source or a second electric voltage source where
the first electric voltage source is connectable to the first and second end of the coolant conduit or to the ends of at least a selected section of the coolant conduit so that an electrical heating current flows in the coolant conduit, and
the second electric voltage source is connectable to at least one coil arrangement adjacent to the at least one coolant conduit so that an electrical heating current is inducible in the at least one coolant conduit by a magnetic field of the coil arrangement, wherein the first and the second end of the coolant conduit are each connected by means of an insulating sleeve with a coolant circuit of a device to insulate the coolant circuit of the device electrically from the coolant conduit.

2. Heat exchanger according to claim 1, the coolant conduit of which is made of metal and the at least one holding clamp of which is made from an electrically non-conductive material.

3. Heat exchanger according to claim 1, wherein the electric voltage source is a low voltage source with direct or alternating voltage.

4. (canceled)

5. Heat exchanger according to claim 1, the insulating sleeve of which comprises a hollow cylindrical body with two opposite ends each comprising an annular gap for the connecting of conduits.

6. Heat exchanger according to claim 5, in which the annular gap is formed by a radial inner wall and a radial outer wall of the insulating sleeve.

7. Heat exchanger according to claim 1, in which at least two sections of the coolant conduit are connected together electrically so that the electrical heating current can spread accordingly.

8. Heat exchanger according to claim 1, wherein the at least one coil arrangement has an annular structure surrounding at least one coolant conduit.

9. Heat exchanger according to claim 1, wherein the at least one coil arrangement has a flat, curved or a shape adapted to the form of the heat exchanger such that the at least one coil arrangement can be arranged adjacent to the heat exchanger.

10. Heat exchanger according to claim 1, wherein the at least one coil arrangement is connected to a controller, by means of which a frequency of an electrical supply voltage of the at least one coil arrangement is adjustable.

11. Heat exchanger according to claim 1, in which the at least one coil arrangement is connected to a controller, which includes a timer for time-dependent activation and deactivation of a magnetic field of the coil arrangement.

12. Heat exchanger according to claim 1, the coolant conduit of which is a wing tube consisting of a tube and a plurality of wings extending radially therefrom, wherein the wings are formed planar and have in the longitudinal direction of the wing tube spaced apart to each other a plurality of openings.

13. Device, in particular a cooling device, an air conditioning device or a dehumidifier comprising a heat exchanger according to claim 1.

14. Insulating sleeve for connecting two conduit ends, comprising the following features:
a. a hollow cylindrical body made of electrically non-conductive material having a first and a second connection end,
b. each connection end having an annular gap for receiving and fastening a conduit end.

15. Insulating sleeve according to claim 14, in which the annular gap is formed by a radial inner wall and a radial outer wall of the insulating sleeve.

16. Insulating sleeve according to claim 14, comprising at least one annular insert, which is insertable into the annular gap in order to keep the conduit end in the annular gap.

17. Insulating sleeve according to claim 14, the annular insert of which is tapered and/or stepped in the axial direction.

18-21. (canceled)

22. Manufacturing method of a heat exchanger with heating, comprising the steps of:
a. providing a coolant conduit having a first and a second end, consisting of an electrically conductive material,
b. placing the coolant conduit in at least one retaining clamp,
c. providing an electrical connection to the first and second end of the coolant conduit or to the ends of at least a section of the coolant conduit to which a first switchable electric voltage source is connectable, so that an electrical current flows through the coolant conduit, and/or
d. providing at least one coil arrangement adjacent to the at least one coolant conduit which is connected to a second switchable electric voltage source, comprising the further step,
e. connecting the coolant conduit by means of an insulating sleeve with a coolant circuit of a device, so that the device is electrically insulated from the coolant conduit.

23. (canceled)

24. Manufacturing method according to claim 22, in which a plurality of coil arrangements is arranged in the heat exchanger.

25. Manufacturing method according to claim 22, comprising the further step:
providing a plurality of openings in at least one wing of the wing tube through which the liquid can drain.

26. De-icing method of a heat exchanger of a device, which has a coolant conduit of electrically conductive material, wherein the de-icing method comprises the steps of:
a. applying a first electric voltage to a first and a second end of the coolant conduit, wherein the first and the second end of the coolant conduit are each connected by means of an insulating sleeve with a coolant circuit of a device to insulate the coolant circuit of the device electrically from the coolant conduit, so that an electrical current flows through the coolant conduit and heats the coolant conduit, and
b. switching off the electric voltage after a time interval, so that the coolant conduit is no longer heated, and/or
a′. applying a second electric voltage to at least one coil arrangement adjacent to the at least one coolant conduit, so that a magnetic field of the at least one coil arrangement induces an electrical heating current in the at least one coolant conduit, and
b′. switching off the electric voltage after a time interval so that the coolant conduit is no longer heated.

27. De-icing method according to claim 26, comprising the further step:
detecting an icing-up on the heat exchanger by means of a sensor,
applying the electrical voltage after a certain degree of icing-up has been reached, and
switching off the electric voltage after a certain period of time or after the icing-up has fallen below a certain degree.

28. De-icing method according to claim 26, comprising the further step of:
thermally monitoring the coolant temperature during the heating of the coolant conduit to prevent overheating of the coolant.

29. Heat exchanger according to claim 12, wherein the openings have a cross-sectional area A_{D} in the range of 2 mm²≦A_{D}≦50 mm².

30. Heat exchanger according to claim 12, wherein the openings are spaced apart from each other at a distance f of 5 mm≦f≦40 mm, more preferably of 10 mm≦f≦30 mm in longitudinal direction of the wing tube.

31. Heat exchanger according to claim 12, wherein the openings are formed approximately in a rectangular, elliptical or round shape.

32. Heat exchanger according to claim 12, wherein the wing tube is made of aluminum.
